(19) United States
(12) Patent Application Publication
(10) Pub. No.: US 2004/0068478 A1
(43) Pub. Date: Apr. 8, 2004

(54) Remote audio-visual instruction system

(76) Inventor: Michael John Stubbs, Gloucestershire (GB)

Correspondence Address: BURNS DOANE SWECKER & MATHIS L L P, POST OFFICE BOX 1404, ALEXANDRIA, VA, 22313-1404, US

(21) Appl. No.: 10/250,695

(22) PCT Filed: Jan. 4, 2002
(86) PCT No.: PCT/GB02/00029

(30) Foreign Application Priority Data
Jan. 5, 2001 (GB) 0100203.9

(51) Int. Cl. G06F 7/00

(52) U.S. Cl. 707/1

(57) ABSTRACT

An information system comprising a database located remotely from a user, the database comprising means, such as a hierarchical index that is optionally responsive to a voice command, to allow a user to select video instructions relating to a specific task, or sub-task, from an array of such data.

This invention relates to a system, including a database and a link to a remote user, for providing user selected instructions, preferably by means of an audio-visual link.

Many human activities can only be properly undertaken if the participant has appropriate instructions on how to undertake the activity. For example retail purchasers are frequently presented with voluminous instructions on how to operate, assemble, use etc., purchased goods or services, these instructions often being abbreviated to allow their presentation in several languages.

It is known for retailers of certain goods, for example Do-it-yourself kitchen ware, to provide videos, typically in VHS™ formats showing how to assemble or install equipment. Manly consumers find such audiovisual instructions more helpful than written instructions and of course it is widely acknowledged a audio-visual communications are more effective than written or audio instructions alone. However, it seems that reluctance of consumers to purchase such videos has, at least in part, presented a barrier to the widespread use of such techniques. It is believed that another impediment has been the general nature of such instructive videos and the difficulty of locating that portion of the recording of relevance to the user when faced with an unexpected problem.

It is an object of the present invention to provide an improved instruction system, preferably using audio-visual instructions retrieved from a remote database by a user.

In one aspect the invention provides an information system comprising a database located remotely from a user, the database having communication means to allow a user to select instructions data, in video format, relating to a product from an array of such data.

The user may select instructions data relating to a sub-task and the data may relate to operating, instructions, installation, assembly troubleshooting or maintenance instructions. The instructions data may relate to instructions for products of a single manufacturer. The user may select by communication means that respond to oral instructions, assimilated using a voice recognition system. The user may also select a preferred language in which to receive instructions.

The instructions data may comprise retrievable graphic images and the data may be stored in analogue or digital format. Preferably the graphical images comprise animated or cinematographic images.

The instructions data may also comprise retrievable text or audio instructions and the audio instructions may be stored in analogue or digital form.

The means used to select an instruction may comprise a microprocessor or the like employing a hierarchical index system or a microprocessor employing a search-engine. The selecting means are responsive to instructions received from the user by the communication means.

The communicating means may comprise a cellular network, a land-line, a radio link, a satellite link, a television link, a computer network or any combination of these means. Preferably, the computer network is the World-Wide-Web (Internet).

The user may view the data using visual image generation means such as a visual display unit, with a microprocessor interface. The microprocessor may comprise a Personal Computer (PC) or Macintosh™ computer.

The selecting means may respond to audio instructions from the user or respond to keyed instructions, mouse selected instructions and the like from a user.

Other aspects of the invention are described in claims 16 to 17.

A specific embodiment of the invention will now be described by reference to the following diagrammatic illustration in which:—

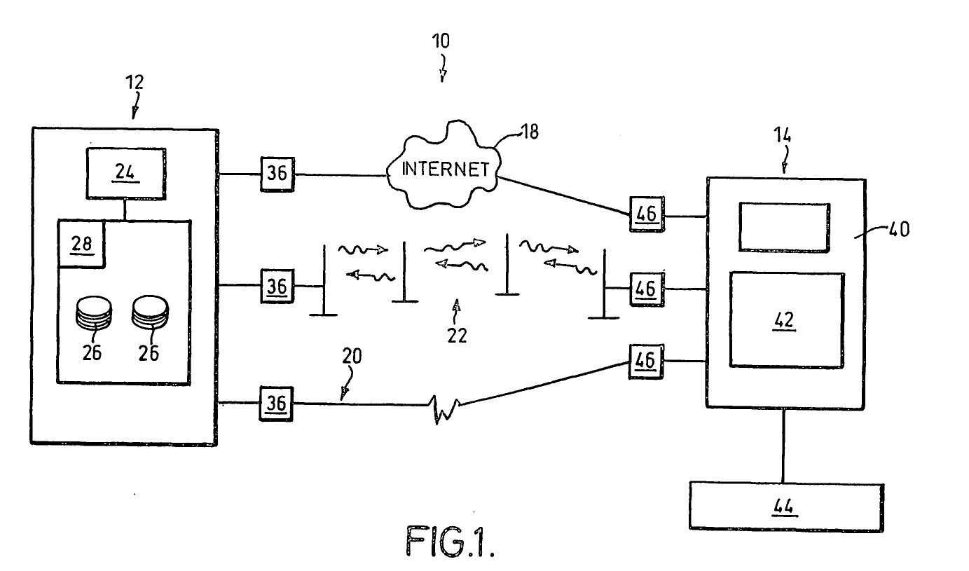

FIG. 1 shows in block flow diagram form the components of the system.

Referring to FIG. 1, a remote audio-visual information system 10 comprises a web server 12 linked by interface mews 36 and 46 with a user/client 14 via the Internet 18 or a land-line 20 or a cellular network 22. The interface means 36,46 may comprise modems or the like. The user 14 receives data via a Persona Computer (PC) 40 with a visual display unit 42 and keyboard 44. Web server 12 contains a processor 24 with means such as a web browser with a video player application for selecting video data files 26 stored in database 28. Database 28 may be stored on hard disc drives, optical discs and the like.

Thus, the user can log-on to the web server 12 via the Internet and select a specified video instruction data file using, for example, a hierarchical index or a search-engine.

The invention is particularly advantageous in that it provides means of selecting a short video sequence relating to a sub-task, thereby avoiding the need to view or fast forward a possibly lengthy video sequence of an entire task; for example, a sub-task comprising a specific step relating to the assembly of a furniture kit. The selection of a sub-task may be achieved by an index system, preferably a hierarchical index system. This feature also allows a user to readily replay a desired instruction sequence if desired in order to fully comprehend the instructions prior to undertaking the instructed task.

The hierarchical index could also be based on selection of manufacturer, then item (such as camera), then model, then function user wishes to obtain instructions about (for example aperture priority or how to unload a film). Thus by progressing through a menu system of this type the user can readily select the specific instruction information sought.

Search engines are well known whereby the user enters keywords or the lice and software loaded on a server searches the database for matching data items, the user selecting the desired item from possibly a plurality of hits.

The communication means may include a voice recognition system. Thus, a user would be able to make desired selections without any keyed input, merely by use of voice commands. This option is particularly suited for use by disabled persons and also by mobile users without a full keypad, in the later case beneficially avoiding multiple key inputs for each iron character. Voice recognition also offers the advantage of improved input speed, especially for unaccomplished typists.

Other means of selecting the required data are also possible including the use of bar-code readers to read codes on goods packaging and selecting means within processor 24 that respond to audio instructions from the user. Having selected the required video data file the user can either download the file to PC 40 for subsequent review or view the data live. In the latter case pause and replay facilities may be included in order to allow the user to view and perform the instructions step by step.

The system of the invention allows the user/client to access the instructions database anywhere in the world, in the car, on the train at home, outdoors etc., over any appropriate communication interface. Suitable interfaces include mobile videophones (for example, microwave based), or land-line videophones, radios, televisions with appropriate user input facilities, laptops and PCs etc.

The system of the invention may be used for a diverse range of applications. It may be used to provide selected instructions on how to use any manufactured product, particularly consumer products, for example goods such as digital cameras. It may also be used to select troubleshooting advice or advice appropriate to more advanced user skills. It is believed that the provision of such systems would engender goodwill from customers at modest or minimal expense to the provider. The system overcomes the common problem of lost instructions and situations where printed instructions have been left behind by the user and so are not available. The system is also ideally suitable for assisting purchasers of goods requiring assembly, for example fixture and Do-it-yourself goods where if the user encounters a difficulty he may access specific instructions on bow to overcome proceed, for example how to configure interconnecting cables between individual electronic units.

The system of the invention could be offered as a service by a single manufacturer or conglomerate; it could be part of a wider service provided by an association of manufacturers on say a World-Wide-Web (Internet) site.

The system has many advantages over sown methods. It provides the potential for one server or network of servers to provide instructions for a multitude of tasks, particularly those relating to consumer purchases. It allows instructions to be segmented into sub-tasks so that a user can request instructions; for example, on how to program the timer of an appliance rather than the entire operating instructions for that appliance. It allows manufacturers to update instructions as and when appropriate and potentially to reduce the size of instruction manuals supplied with the product. It also overcomes the perceived barrier of VHS™ video tape purchase costs by providing selected instructions in an accessible format while avoiding the manufacturing and distribution costs of VHS™ format instructions.

1. An information system comprising a database located remotely from a user, the database having communication means to allow a user to select suctions data, in video format, relating to a product from an array of such data

2. An information system according to claim 1 wherein the user may select instructions data relating to a sub-task.

3. An information system according to any preceding claim wherein the information database relates to operating, instructions, installation, assembly troubleshooting or maintenance instructions.

4. An information system according to any preceding claim wherein the information database relates to instructions for products of a single manufacturer.

5. An information system according to any preceding claim wherein the user selects data using a search-engine or index system.

6. An information system according to any preceding claim wherein the user selects data using a hierarchical index system.

7. An information system according to any preceding claim wherein means are provided to pause the video instruction.

8. An information system according to any preceding claim wherein means are provided to replay an instruction relating to a task or sub task.

9. An information system according to any preceding claim wherein the user selects data by means respond to oral instructions, assimilated using a voice recognition system.

10. An information system according to any preceding claim wherein the user selects data by reading a bar-code on the product or the product packaging.

11. An information system according to any preceding claim wherein a user may select a preferred language in which to receive instructions.

12. An information system according to any preceding claim wherein the user locates an appropriate site on the World-Wide-Web (Internet) by means of reading a bar-code on the product or the product packaging.

13. An information system according to any preceding claim where the user views instructions data in teat form.

14. An information system according to any preceding claim wherein the user views the data using visual image generation means with a microprocessor interface.

15. An information system according to any preceding claim wherein the communicating means comprises a cellular network, a land-line, a radio link, a microwave link, a satellite link, a television link, a computer network or any combination thereof.

16. An information system comprising a database located remotely from a user, the database comprising means to allow a user to select instructions data relating to a specific task from an array of such data, means of communicating with the user thereby allowing the user to hear selected instructions data.

17. An information system comprising a database located remotely from a user, the database comprising means to allow a user to select instructions data relating to a specific task from an array of such data, means of communicating with the user thereby allowing the user to view the selected data.
